(19) United States
(12) Patent Application Publication
(10) Pub. No.: US 2007/0175673 A1
(43) Pub. Date: Aug. 2, 2007

(54) Weight/Volume Scale

(76) Inventor: Theodore Prins, Burnsville, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/668,095

(22) Filed: Jan. 29, 2007

Related U.S. Application Data
(60) Provisional application No. 60/763,227, filed on Jan. 30, 2006.

(51) Int. Cl. G01G 19/22; G01G 19/34

(52) U.S. Cl. 177/25.13

(57) ABSTRACT

A device for volumetric measurement of materials of interest is disclosed which includes a weight determining unit for generating weight-related output signals based on the weight of an object species placed on a platform, a central processing unit (CPU) for receiving and processing weight related output signals and producing a corresponding volume output signal, a data input unit connected to the CPU for transmitting information identifying the object species for use by the CPU, an output display for displaying a result based on the output signal and identifying information and a power source for operating the device.

### BACKGROUND OF THE INVENTION

I. Field of the Invention

The present invention relates generally to the accurate volume measurement of materials, commonly measured by hand using eye estimates such as culinary ingredients, based on weight. This is accomplished conveniently by means of a portable automated weight/density conversion scale. More particularly, the invention provides a relatively inexpensive digitized measuring device that enables easy accurate, repeatable measuring for ingredients of many types for recipes and other uses.

II. Related Art

Scales have long been used to measure the weight of particular items in commonly accepted measuring units such as pounds, ounces or grams. Measurement by volume, particularly small volume amounts, on the other hand, is not done using an accurate scale, but rather by filling volume measuring vessels ranging in size from fractions of teaspoons to tablespoons to cups and liters to a desired level. Measurements by individuals using volume measurement devices has long been a problem as a measured amount is a matter of relative judgment and interpretation by individuals. It has been shown that people tend to interpret such volume measurements differently and inconsistently. Thus, incorrect measuring using a volume measuring container is very common and differences as much as 20% or greater are seen when comparing measuring results from two different people. This is particularly true with loosely packed dry ingredients which may include large amounts of air space in the volume of the component being measured.

Accordingly, there is a need for a simple device that enables accurate, repeatable volume measurements to be made for a large number of ingredient materials to ensure correct and consistent measurement results which do not depend on the interpretation of individual people.

### SUMMARY OF THE INVENTION

By means of the present invention, there is provided a relatively inexpensive but accurate measurement tool that displays a volume measurement based on the weight of an ingredient or component placed on a load receiving element such as a weighing pan, platform, scoop, hook or the like for receiving items to be measured. The system includes a power source, which may be a rechargeable battery or the like to provide electrical energy to run the system, and a scale having a load cell, or the like, which generates an output signal based on deflection produced by the weight of an object placed on or attached so as to deflect the cell. A central processing unit (CPU), preferably in the form of a microprocessor including an amount of memory, is provided on a circuit board and connected to the other components, including the power source, the load cell and an input keyboard. A digital output system is also provided which is connected to the microprocessor and which includes an output display, preferably an LCD display and may also include a printer or other additional output device.

In one illustrative embodiment, the CPU is programmed with many conversion codes which may be keyed to a number system and each of which presents a weight to volume conversion for a particular named common ingredient. The system can be programmed to convert in terms of any convenient conversion units, such as ounces to cups or grams to liters. In addition, conversion units from grams to cups or ounces to liters can also be used. The output may conveniently be subdivided to include fractions of cups or liters plus tablespoons. Alternatively, decimal fractions can also be used. Fractional or decimal parts of teaspoons or tablespoons may be used to indicate the weight of small amounts of materials such as spices or flavorings. In addition, any graduation system may be used in the conversion which may combine, for example, fractional cup and tablespoon measurements in any desired amount.

### BRIEF DESCRIPTION OF THE DRAWINGS

In the drawings, wherein like numerals depict like parts throughout the same:

FIG. 1 is a schematic perspective representation of a possible embodiment of the invention;

FIG. 2 is a schematic representation of an embodiment of the automated weight/volume scale system of the invention; and

FIG. 3 is a flow chart illustrating typical steps in the use of the system of FIG. 1.

### DETAILED DESCRIPTION

The following detailed description includes an illustrative embodiment which is meant to present an example of the inventive concept but should not be taken as limiting in any respect. It should further be noted that whereas the detailed account may recite culinary ingredients and uses, the present invention may be used anywhere similar measurements are required and conversion codes may be provided accordingly. Such applications will occur to those skilled in the art.

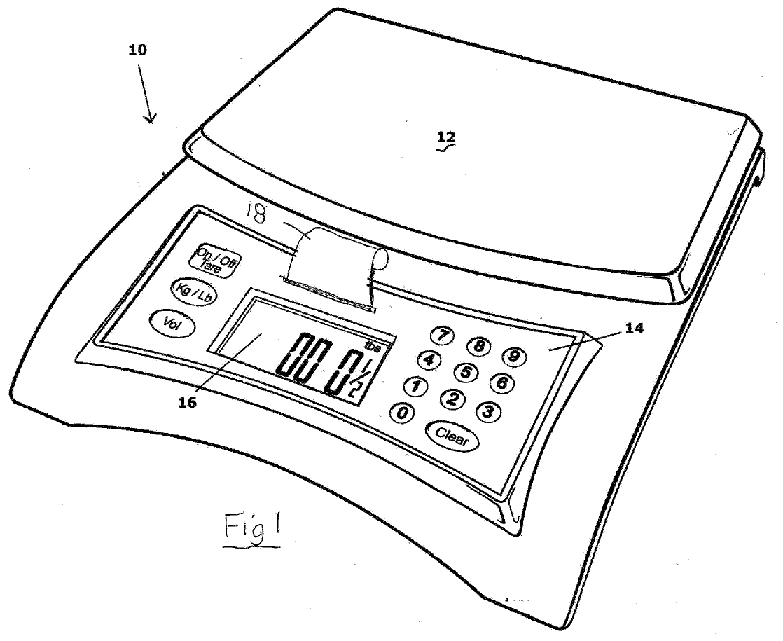

FIG. 1 is a schematic perspective view of an embodiment of a weight/volume scale in accordance with the invention which is shown generally at 10 and includes a weigh platform 12 and raised keyboard 14 with LCD output shown at 16. A printed output is shown at 18,

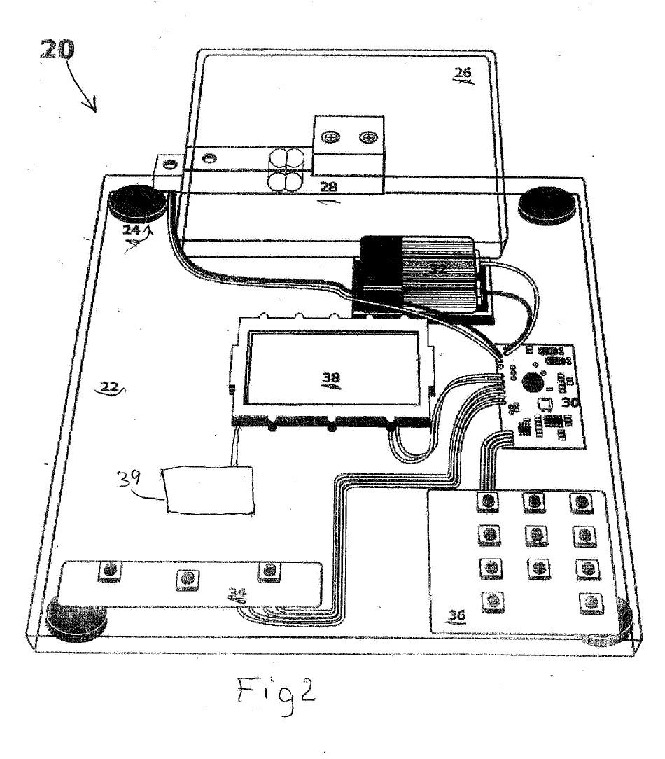

FIG. 2 is a schematic representation of an embodiment of the weight/volume scale of the invention similar to that in FIG. 1 with internal parts exposed for clarity. The system shown generally at 20 includes a base or chassis member 22 with associated soft padded feet as at 24 designed to rest on a surface on which the device is to be used. A load receiving element 26, which may be a weighing pan, platform, scoop, hook or any other such device, is shown atop a strain gauge load cell 28 which senses the weight of an object placed in the load receiving element 26, the weight of the load receiving element itself having been compensated. The strain gauge load cell 28 deflects to sense the weight of an object and produces an electric signal output proportional to the deflection which is conducted to a central circuit board 30 which contains the CPU and other conventional control and processing elements. A power source in the form of a battery is shown at 32, also connected to the main electronic circuit board. Keyboard inputs are shown at 34 and 36 and a digital output display is shown at 38 and a printer module is shown at 39.

An external chart or key may be provided with a series of numbers which correspond to the measurement of common items such as flour, types of sugar and other commonly used ingredients which can be displayed on the display as selected using the keyboard. For example, the CPU can be programmed with 999 conversion codes from code 001 to code 999 which correspond to different ingredients or different conversion units between weight and volume. Each selected code will appear in the digital display prior to the weighing of the ingredient so that the user knows that the correct component is being sensed and the correct units will be displayed. The key or chart can also be programmed into a system memory so that the display will show the corresponding ingredients based on the code input. In this manner, the CPU can be programmed with almost unlimited number of conversion codes, each code carrying its own conversion key. Based on the corresponding weight/volume ratio, the CPU will make a conversion from the electrical output signal received from the weigh scale load cell into a volume measuring unit displayed on the display 28. The entire system may be contained in a rather small portable device enclosed in a plastic housing or the like (not shown).

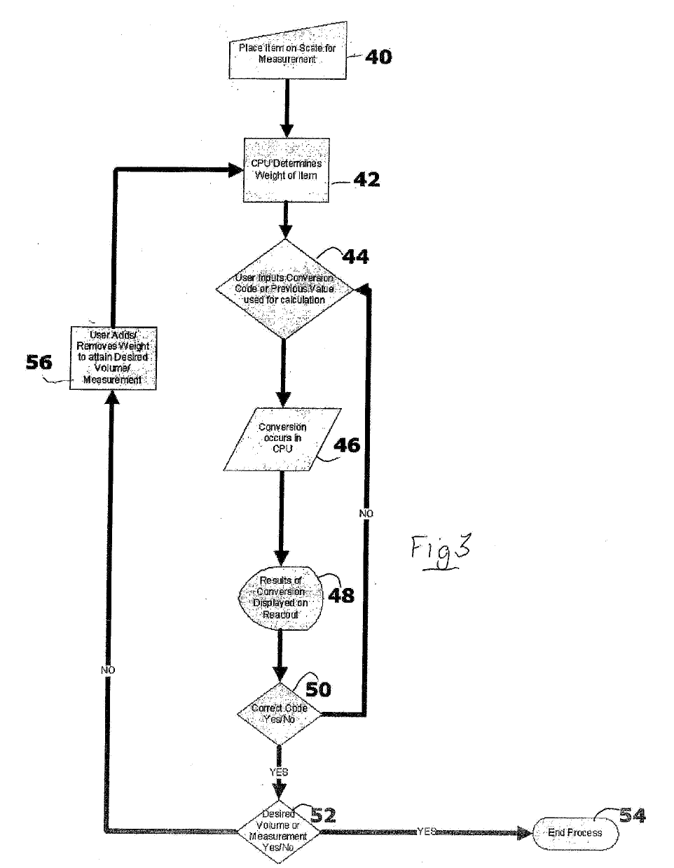

FIG. 3 depicts a flow chart illustrating a typical operating sequence for using the weight/volume scale system of the invention. The process begins at 40 with an item known to the user being placed on the load receiving element of the scale for measurement. This may be an amount of a dry ingredient such as flour or granulated sugar or a liquid in a container, the tare weight of which has been compensated for prior to adding the liquid ingredient. The central processing unit then determines the net weight of the item added to the load receiving element based on the proportional electric output of the stain gauge load cell at 42. The user then inputs the conversion code based on the material being weighed or, if the same material is being weighed, the previous value can be used for calculation at 44. At 46, the conversion in the CPU is noted and a volume output reading appears in the digital display at 48 along with the code use so that this may be checked for accuracy at 50. If the incorrect code has been used, the correct code can then be re-entered at 44 and a conversion repeated based on the re-entered code. If the correct code has been entered as checked at 50, the desired volume is then compared by the user to the measured volume at 52 and if the measurement is correct, the weighing sequence is ended at 54. If the volume measurement is incorrect, weight can be added or removed from the load receiving element at 56 and the process repeated until the correct volume has been achieved.

### EXAMPLE 1

Two different ingredients are measured, namely, granulated sugar and molasses. If granulated sugar is given code 51 and molasses code 89, the CPU is programmed with conversions for code 51 and code 89:

### Code 51:

1 cup of granulated sugar equals 200 grams

1 tablespoon of granulated sugar equals 12.5 grams

### Code 89:

1 cup of molasses equals 337 grams

1 tablespoon of molasses equals 21 grams

### When placing an ingredient on the weighing platform and entering a code that corresponds with the item being weighed, the CPU calculates the volume based on the pre-programmed conversion factors.

When using the above mentioned ingredients and their corresponding codes of 51 and 89 for some random measurements of, say 310 grams of granulated sugar and 765 grams of molasses, the following results occur:

310 grams of granulated sugar shows 1½ cup and 1 tablespoon, explained:

1½ cup equals 300 grams (1.5×200=300)

1 tablespoon equals 12.5 grams

Rounded total for 312.5 grams is 1½ cup and 1 tablespoon

765 grams of molasses shows 2¼ cup and ½ tablespoon, explained:

2¼ cup equals 758 grams (2.25×337=758)

½ tablespoon equals 10.5 grams

Rounded total for 768.5 grams is 2¼ cup and ½ tablespoon

Possible programming of the CPU using the conversion volume measurement of 16 tablespoons per cup measurements can be made using a combination of cups and tablespoons according to the following chart graduated in ½ (0.5) tablespoons:

| Cup | Tablespoon |
|---|---|
| 0 | 0 |
| 0 | ½ |
| 0 | 1 |
| 0 | 1½ |
| ⅛ | 0 |
| ⅛ | ½ |
| ⅛ | 1 |
| ⅛ | 1½ |
| ¼ | 0 |
| ¼ | ½ |
| ¼ | 1 |
| ⅓ | 0 |
| ⅓ | ½ |
| ⅓ | 1 |
| ⅓ | 1½ |
| ⅓ | 2 |
| ½ | 0 |
| ½ | ½ |
| ½ | 1 |
| ½ | 1½ |
| ½ | 2 |
| ⅔ | 0 |
| ⅔ | ½ |
| ⅔ | 1 |
| ¾ | 0 |
| ¾ | ½ |
| ¾ | 1 |
| ¾ | 1½ |
| ¾ | 2 |
| ¾ | 2½ |
| ¾ | 3 |
| ¾ | 3½ |
| 1 | 0 |
| 1 | ½ |
| 1 | 1 |
| 1 | 1½ |
| 1⅛ | 0 |
| etc | |

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A device for volumetric measurement of materials of interest comprising:
(a) a weight determining unit including a load receiving platform and a deflectable element for generating weight-related output signals based on the weight of an object species placed on said platform;
(b) a central processing unit (CPU) for receiving signals from said load cell, processing said signals and producing a corresponding volume output signal;
(c) a data input unit connected to said CPU for transmitting information identifying said object species for use by said CPU;
(d) an output display for displaying a result based on said output signal and said identifying information; and
(e) a power source for operating said device.

2. A device as in claim 1 wherein said deflectable element is a strain gauge load cell.

3. A device as in claim 1 wherein said output display includes a liquid crystal device.

4. A device as in claim 1 which is portable.

5. A device as in claim 1 including a printer for printing a result including the identity of the object species measured.

6. A device as in claim 1 wherein said CPU includes a weight/volume conversion table and a look-up table corresponding to a plurality of ingredient materials.

7. A device as in claim 1 wherein said output is available in a plurality of units including English and metric units.

8. A device as in claim 1 wherein said data input unit is a keyboard.

9. A device as in claim 1 wherein said data input is in the form of an object species identification code.

10. A device as in claim 8 wherein said data input is in the form of an object species identification code.

11. A method of measuring the volume of culinary ingredients comprising:
(a) using a weight determining unit to determine the weight of an amount of an identified species of interest;
(b) using a conversion code to convert the weight of said species of interest to a corresponding volume measurement; and
(c) adjusting the amount of weighed material to attain the desired volume measurement.

12. A method as in claim 11 including verifying the code of the ingredient of interest in order to verify the volume measurement.

13. A method as in claim 11 further including selecting volume units to be displayed.

14. A method as in claim 11 further including printing results.
